(19) United States
(12) Patent Application Publication
(10) Pub. No.: US 2015/0322223 A1
(43) Pub. Date: Nov. 12, 2015

(54) TRANSPARENT POLYIMIDE SUBSTRATE AND METHOD FOR FABRICATING THE SAME

(71) Applicant: KOLON INDUSTRIES, INC., Gwacheon-si, Gyeonggi-do (KR)

(72) Inventors: Hack Yong WOO, Yongin-si (KR); Hak Gee JUNG, Yongin-si (KR); Hyo Jun PARK, Yongin-si (KR)

(73) Assignee: KOLON INDUSTRIES, INC., Gwacheon-si, Gyeonggi-do (KR)

(21) Appl. No.: 14/649,601

(22) PCT Filed: Dec. 10, 2013
(86) PCT No.: PCT/KR2013/011382

§ 371 Date: Jun. 4, 2015

(30) Foreign Application Priority Data
Dec. 12, 2012 (KR) 10-2012-0144164

(51) Int. Cl. C08J 7/04; B29C 71/02; B05D 3/06

(52) U.S. Cl. CPC C08J 7/045; B05D 3/067; C08J 7/047; C08J 7/08; C08J 2451/08; C08J 2379/08

(57) ABSTRACT

The present invention provides a transparent polyimide substrate comprising a transparent polyimide film and a cured layer of a polyisocyanate formed on at least one surface of the transparent polyimide film, the polyisocyanate containing an acrylate group and having 2 to 5 isocyanate groups per molecule. The transparent polyimide substrate has excellent scratch resistance, solvent resistance, optical properties and flexibility and low water permeability and is useful as a cover substrate for a flexible electronic device.

### TECHNICAL FIELD

The present invention relates to a transparent polyimide substrate useful as a cover substrate in a flexible electronic device and to a method for fabricating the same.

### BACKGROUND ART

In recent years, among next-generation displays, electron devices that can be curved or bent have received attention, including flexible OLEDs, flexible PVs, lightweight displays, flexible encapsulating materials, color EPDs, plastic LCDs, TSPs, OPVs and the like. In order to realize such flexible displays and protect elements in the displays, a new type of flexible cover substrate to substitute for a conventional glass cover substrate is required. In addition, this substrate is required to have high hardness, low moisture permeability, high chemical resistance and high light transmission in order to protect the elements included in the display devices.

As materials for such flexible display cover substrates, a variety of high-hardness plastic substrates have been proposed as candidates, and among them, a transparent polyimide film that can have high hardness while maintaining thinness has been proposed as a major candidate.

In the prior art, in order to increase the hardness of the transparent polyimide film proposed as the material of a cover substrate for a flexible electronic device, a cured acrylic or epoxy-based organic layer was formed on the transparent film. However, this cured organic layer was not flexible, and for this reason, the surface thereof was cracked when the bending property was evaluated.

Korean Patent Laid-Open Publication No. 10-2012-0078514 (published on Jul. 10, 2012) discloses a transparent polyimide substrate having solvent resistance and high heat resistance, which is fabricated by forming a silicon oxide film on one or both surfaces of a transparent polyimide film that is a flexible substrate material. This transparent polyimide substrate is excellent in terms of various properties, including solvent resistance, light transmittance, yellowness and thermal properties, but the silicon oxide layer alone does not provide sufficient scratch resistance required for a cover substrate.

### DISCLOSURE

### Technical Problem

It is an object of the present invention to provide a transparent polyimide substrate which has excellent scratch resistance so as to prevent a flexible electronic device from being scratched, and thus is useful as a cover substrate in the flexible electronic device.

### Technical Solution

In an embodiment, the present invention provides a transparent polyimide substrate comprising a transparent polyimide film and a cured layer of a polyisocyanate formed on at least one surface of the transparent polyimide film, the polyisocyanate containing an acrylate group and having 2 to 5 isocyanate groups per molecule.

In a specific embodiment, the polyisocyanate may be an isocyanate compound represented by the following formula 1 and containing an acrylate group:

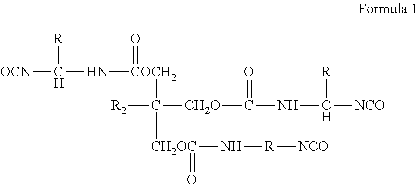

wherein R is

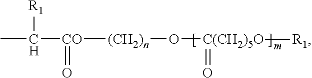

wherein n is an integer ranging from 0 to 5, m is an integer ranging from 1 to 5, and R₁ is a hydrogen atom or an alkyl group having 1 to 3 carbon atoms; and R₂ is an alkyl group having 1 to 5 carbon atoms.

In a preferred embodiment of the present invention, the cured layer in the transparent polyimide substrate may have a thickness of 1.0-20.0 μm in view of hardness and flexibility.

In an embodiment of the present invention of the present invention, the transparent polyimide substrate may further comprise a silicon oxide layer formed between the transparent polyimide film and the cured layer in order to further improve the solvent resistance, water permeability and optical properties thereof, the silicon oxide layer comprising a unit structure represented by the following formula 2:

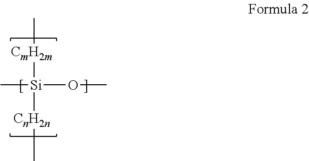

wherein m and n are each an integer ranging from 0 to 10.

In a preferred embodiment of the present invention, the silicon oxide layer in the transparent polyimide substrate may have a thickness of 0.3-2.0 μm in view of suitable solvent resistance and flexibility.

In another embodiment, the present invention provides a method for fabricating a transparent polyimide substrate, the method comprising the steps of: applying a solution containing a polyisocyanate to at least one surface of a transparent polyimide film, the polyisocyanate containing an acrylate group and having 2 to 5 isocyanate groups per molecule, and drying the applied solution, thereby forming a coating layer; and curing the coating layer to form a cured layer.

In a preferred embodiment of the method of the present invention, the polyisocyanate may be represented by formula 1.

In view of UV curability, the solution containing the polyisocyanate may further contain a photoinitiator selected from the group consisting of a benzoin ether photoinitiator, a benzophenone photoinitiator and a combination thereof.

In a preferred embodiment of the method of the present invention, the step of curing the coating layer to form the cured layer is performed by irradiating the coating layer with UV light having a short-wavelength of 312 nm or 365 nm at a dose of 1,500-10,000 J/m².

In a preferred embodiment, the method for fabricating the transparent polyimide substrate may further comprise, before the step of applying the solution to at least one surface of the transparent polyimide substrate, a step of applying a solution containing a polysilazane to the transparent polyimide film, drying the applied polysilazane solution, and curing the polysilazane to form a silicon oxide layer.

In a specific embodiment of the method of the present invention, the polysilazane may comprise a unit structure represented by the following formula 3, and the silicon oxide layer may comprise a unit structure represented by formula 2:

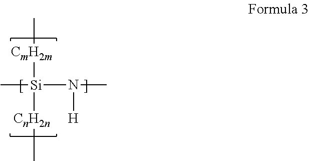

wherein m and n are each an integer ranging from 0 to 10.

In a preferred embodiment of the method of the present invention, the step of curing the applied polysilazane to form the silicon oxide layer may be performed by heat-treating the applied polysilazane at a temperature of 200˜300° C.

### Advantageous Effects

The present invention provides a transparent polyimide substrate having excellent scratch resistance, solvent resistance, optical properties and flexibility and low water permeability. The transparent polyimide substrate is useful as a cover substrate for a flexible electronic device.

### BEST MODE

Hereinafter, the present invention will be described in further detail.

A transparent polyimide substrate according to the present invention comprises a cured layer of a polyisocyanate compound formed on at least one surface of a transparent polyimide film, the polyisocyanate compound containing an acrylate group. The cured layer functions as a hard coating layer.

As used herein, the term “polyisocyanate compound” refers to an organic compound having a plurality of isocyanate groups per molecule. The polyisocyanate compound preferably contains no more than 5 isocyanate groups per molecule.

This polyisocyanate compound may react with an acrylic resin having a hydroxyl group to form a polyisocyanate compound containing an acrylate group. When the polyisocyanate compound containing an acrylate group is applied to a transparent polyimide film and cured, it can be crosslinked to provide a coating layer having improved physical properties.

If the polyisocyanate compound containing an acrylate compound has more than 5 isocyanate groups, it will be advantageous in terms of hardness, but it will have a high degree of crosslinking, which can reduce the bending property that is the important property of a flexible cover film. Examples of an isocyanate compound having 2 isocyanate groups per molecule include diisocyanate monomers such as tolylene diisocyanate, naphthalene diisocyanate, xylylene diisocyanate, and norbornene diisocyanate. Such diisocyanate monomers can react with an acrylic resin having a hydroxyl group to form diisocyanate compounds containing an acrylate group.

Meanwhile, a polyisocyanate compound having more than 3 isocyanate groups per molecule can react with an acrylic resin having a hydroxyl group to form the polyisocyanate of formula 1.

This polyisocyanate compound containing an acrylate group, when cured, functions to improve the physical properties of the film, particularly the scratch resistance.

The cured layer formed of the polyisocyanate containing an acrylate group preferably has a thickness of 1.0-20.0 μm. In order to ensure a pencil hardness of H or harder on the film, the cured layer preferably has a thickness of 1 μm or more, and in order to prevent the flexibility of the transparent polyimide substrate from being reduced by the cured layer, the cured layer preferably has a thickness of 20.0 μm or less.

The cured layer formed of the polyisocyanate containing an acrylate group can be formed by a series of processes that include applying a solution containing the polyisocyanate having an acrylate group to one or both surfaces of a transparent polyimide film and drying and curing the applied solution.

Herein, the process of applying the solution containing the polyisocyanate having an acrylate group to one or both surfaces of the transparent polyimide film can be performed using a suitable method selected from among spray coating, bar coating, spin coating, dip coating and the like.

The curing process may be performed by a UV curing method, and in view of this UV curing process, the solution containing the polyisocyanate may contain a photoinitator.

Examples of the photoinitiator include a benzoin ether photoinitiator, a benzophenone photoinitiator and a combination thereof.

In the UV curing process, the polyisocyanate can be cured by irradiating it with UV light having a wavelength of 312 nm or 365 nm at a dose of 1500-10,000 J/m².

Meanwhile, the transparent polyimide substrate of the present invention may further comprise, between the transparent polyimide film and the cured layer (hard coating layer), a silicon oxide layer comprising a silicon oxide comprising a unit structure of formula 2.

When the inorganic silicon oxide layer is formed on one or both layers of the transparent polyimide film, it can impart excellent solvent resistance and heat resistance to the surface of the polyimide film.

When the inorganic silicon oxide layer is a pure inorganic layer in which n or m in formula 2 is 0, it can maximize solvent resistance and heat resistance of the substrate. In some case, in order to improve the flexibility of the transparent polyimide substrate, the inorganic silicon oxide layer preferably has an alkyl chain having a suitable length. In other words, the inorganic silicon oxide layer is preferably one in which n or m in formula 2 is 1 or more. However, if n or m in formula 2 is more than 10, the carbon dioxide particles in the coating solution can agglomerate due to their hydrophobicity in the coating process.

The silicon oxide layer preferably has a thickness of 0.3-2.0 μm. In order words, to ensure sufficient solvent resistance, the silicon oxide layer preferably has a thickness of 0.3 μm or more, and to prevent a decrease in the flexibility of the transparent polyimide substrate, the silicon oxide layer preferably has a thickness of 2.0 μm or less.

The inventive transparent polyimide substrate having the silicon oxide layer formed thereon can have improved physical properties, including high optical transmittance, low yellowness and low moisture permeability. Low moisture permeability is an essential factor for protecting TFT and OLED devices from a humid external environment.

When the silicon oxide layer is formed on the surface of the transparent polyimide substrate of the present invention, the surface roughness (RMS) of the substrate can be 2 nm or less, and the substrate has a planarized surface. This planarized surface can facilitate the transfer of carriers when an electrode or a TFT is formed.

The method for fabricating the transparent polyimide substrate of the present invention comprises forming the silicon oxide layer on one or both surfaces of a transparent polyimide film. Specifically, the method comprises the steps of: applying a polysilazane-containing solution to one or more surfaces of a transparent polyimide film; drying the applied solution; and curing the polysilazane.

When the polysilazane applied to at least one surface of the transparent polyimide film is cured, a —NH— group in the unit structure of formula 3 is converted into an —O— group as shown in the unit structure of formula 2, thereby forming the silicon oxide layer. Herein, the curing is preferably performed by a thermal curing method in which the polysilazane is heat-treated at a temperature of 200˜300° C.

In the thermal curing method, the polysilazane is easily formed into a silicon oxide layer having a network structure. Thus, the formed silicon oxide layer is hard in nature and has very excellent chemical resistance and heat resistance.

When the thermal curing method is adopted, it can be performed by heat-treating the applied polysilazane at a temperature of 200˜300° C.

When the heat-treatment temperature is 200° C. or higher, the time required for curing the polysilazane to form the silicon oxide layer can be shortened, and when the temperature is 300° C. or lower, distortion can be prevented from being caused by the difference in the thermal expansion coefficient between the transparent polyimide film and the silicon oxide layer.

A conventional vapor deposition process (such as PECVD or sputtering) for forming an inorganic material on a surface has a shortcoming in that an area for deposition is limited due to limited vacuum equipment. However, the inventive method of curing the applied solution to form the inorganic layer has an advantage in that it can be performed by a simple casting process at atmospheric pressure, and thus can be performed continuously in a large area.

The polysilazane may comprise the unit structure of formula 3 and have a weight-average molecular weight of 3,000-5,000 g/mol.

The molecular weight described herein is a weight-average molecular weight determined relative to a standard substance (0.1% polystyrene in methylethylketone) by gel permeation chromatography (GPC) (S-3580, SYKAM RI). The polymer to be measured was dissolved in THF at a concentration of 0.1 wt %, and 50 mL of the polymer solution was injected into GPC. A mobile phase used in GPC was 25 mM LiBr and 3-mM H₃PO₄ in THF:MEK (1:1), the flow rate was 1 mL/min, and analysis was performed at 50° C. The column used was composed of two Styragel HR 5E columns and one Styragel HR 4E column connected to each other in series. The detector used was Sykam RI S-3580, and measurement was performed up to 50° C.

m and n in formula 3 can be suitably selected depending on the properties of the resulting silicon oxide layer. To ensure improved solvent resistance and high heat resistance, the polysilazane may have a weight-average molecular weight of 3,000 or more, and to ensure a uniform coating property, the the polysilazane may have a weight-average molecular weight of 5,000 or less.

The process of applying the polysilazane-containing solution to one or both surfaces of the transparent polyimide film can be performed using a suitable method selected from among spray coating, bar coating, spin coating, dip coating and the like.

Hereinafter, the present invention will be described in further detail with reference to examples.

### Preparation Example 1

### 1-1: Preparation of Polyimide Powder

Into a 1-liter reactor equipped with a stirrer, a nitrogen inlet, a drop funnel, a temperature controller and a condenser, 832 g of N,N-dimethylacetamide (DMAc) was charged under a nitrogen atmosphere. Then, the internal temperature of the reactor was controlled to 25° C., and 64.046 g (0.2 mol) of bistrifluoromethyl benzidin (TFDB) was dissolved in the solvent in the reactor, and the solution was maintained at 25° C. Then, 31.09 g (0.07 mol) of 2,2-bis(3,4-dicarboxyphenyl)hexafluoropropane dianhydride (6FDA) and 8.83 g (0.03 mol) of biphenyl tetracarboxylic dianhydride (BPDA) were added thereto and stirred for a predetermined time at 25° C. Then, 20.302 g (0.1 mol) of terephthaloyl chloride (TPC) was added thereto to obtain a polyamic acid solution having a solid content of 13 wt %. To the polyamic acid solution, 25.6 g of pyridine and 33.1 g of acetic anhydride were added, and the mixture was stirred at 25° C. for 30 minutes and then at 70° C. for 1 hour. The stirred mixture was cooled to room temperature and precipitated with 20 L of methanol, and the precipitated solid was filtered, triturated, and then dried in a vacuum at 100° C. for 6 hours to yield 111 g of a polyimide as solid powder.

### 1-2: Preparation of Polyimide Film

0.03 g (0.03 wt %) of amorphous silica particles having a OH group bound to the surface were dispersed in N,N-dimethylacetamide (DMAc) at a concentration of 0.1% and sonicated until the solvent became clear. Then, 100 g of the polyimide powder was dissolved in 670 g of N,N-dimethylacetamide (DMAc) at a concentration of 13 wt %. The resulting solution was applied to a stainless steel plate, and then cast to a thickness of 340 μm and dried in hot air at 130° C. for 30 minutes. The resulting film was detached from the stainless steel plate and fixed to a frame by a pin. The frame having the film fixed thereto was placed in a vacuum oven and heated slowly from 100° C. to 300° C. for 2 hours, followed by slow cooling. Then, the film was separated from the frame, thereby obtaining a polyimide film. Then, the polyimide film was heat-treated at 300° C. for 30 minutes. The prepared polyimide film had a thickness of 50 μm, an average optical transmittance of 88%, a yellowness of 3.0, and an average coefficient of thermal expansion (CTE) of 20 ppm/° C. as measured at 50˜250° C. according to the TMA method.

### Comparative Example 1

The polyimide film prepared in Preparation Example 1 was used as Comparative Example 1.

### Comparative Example 2

A polysilazane (MOPS-1800, Az Materials), in which m and n in formula 3 is each 0 and which has a weight-average molecular weight of 2,000 g/mol, was dissolved in dibutyl ether (DBE) at a concentration of 2 wt %. The solution was applied on one surface of the colorless and transparent polyimide film of Comparative Example 1 by a wire, and then dried at a temperature of about 80° C., thereby forming a polysilazane layer having a thickness of 300 nm.

Then, the resulting film was allowed to stand at room temperature for about 5 minutes, after which the polysilazane layer was thermally cured at a temperature of about 250° C. to form a silicon oxide layer, thereby preparing a substrate having a structure consisting of colorless transparent polyimide film/silicon oxide layer.

### Comparative Example 3

A substrate having a structure consisting of silicon oxide layer/colorless transparent polyimide film/silicon oxide layer was prepared in the same manner as described in Comparative Example 2, except that the polysilazane solution was applied to both surfaces of the colorless transparent polyimide film.

### Example 1

A coating solution containing the acrylate-containing polyisocyanate of formula 1 (m=2, n=2, R₁=methyl group, R₂=ethyl group) and a photoinitiator (3 wt %, PI 981, Chempia Co., Ltd.) was applied to one surface of the colorless transparent polyimide film using a dip coater, and then dried at a temperature of 80° C., thereby obtaining a coating layer having a thickness of 10 μm. Then, the coating layer was irradiated with UV light having wavelengths of 312 nm and 365 nm at a dose of 100 mw/cm² for 10 seconds, thereby obtaining a colorless transparent polyimide film having a structure consisting of colorless transparent polyimide film/cured layer of acrylate-containing polyisocyanate.

### Example 2

A colorless transparent polyimide film having a structure consisting of cured layer of acrylate-containing polyisocyanate/colorless transparent polyimide film/cured layer of acrylate-containing polyisocyanate was prepared in the same manner as described in Example 1, except that the cured layer was formed on both surfaces of the colorless transparent polyimide film.

### Example 3

On the silicon oxide layer formed on one surface of the colorless transparent polyimide film as described in Comparative Example 2, the cured layer formed of the acrylate-containing polyisocyanate was formed in the same manner as described in Example 1, thereby preparing a substrate having a structure consisting of colorless transparent polyimide film/silicon oxide layer/cured layer of acrylate-containing polyisocyanate.

### Example 4

On the silicon oxide layers formed on both surfaces of the colorless transparent polyimide film as described in Comparative Example 3, the cured layer formed of the acrylate-containing polyisocyanate was formed in the same manner as described in Example 1, thereby preparing a substrate having a structure consisting of cured layer of acrylate-containing polyisocyanate/silicon oxide layer/colorless transparent polyimide film/silicon oxide layer/cured layer of acrylate-containing polyisocyanate.

The colorless transparent polyimide films prepared in the Examples and the Comparative Examples were measured for surface hardness, optical properties and other physical properties in the following manner.

Method for measurement of physical properties

Physical properties were measured in the following manner, and the results of the measurement are shown in Table 1 below.

(1) Average Light Transmittance (%)

Average light transmittance at 350-700 nm was measured using a spectrophotometer (CU-3700D, KONICA MINOLTA).

(2) Yellowness

Yellowness was measured using a spectrophotometer (CU-3700D, KONICA MINOLTA).

(3) Water Permeability (g/m²*day)

Water permeability (WVTR) was measured using a MOCON/US/Aquatran model-1.

(4) Pencil Hardness

A 50 mm line was drawn five times on the film with a Mitsubishi pencil using an electric-powered pencil tester under a load of 1 kg at a speed of 180 mm/min, and then the pencil hardness in which no scratch appeared on the surface was recorded.

(5) Adhesion (Attaching and Detaching a Tape 100 Times)

Adhesion was measured using a tape test according to ASTM D3359.

(6) Bending Property

The substrate was repeatedly wound and unwound around a 10 mm-diameter circular tool, and whether the layer was cracked was observed visually and with a microscope. The sample having cracking was recorded as ‘Failed’, and the sample having no cracking was recorded as ‘OK’.

(7) Scratch Resistance

The substrate was rubbed 500 times with steel wool by a length of 100 mm under a load of 500 g at a speed of 50 mm/sec, and then the number of scratches on the substrate was measured visually and with a microscope. Evaluation results were rated on the following criteria: ⊚: no scratch; Δ: 1-5 scratches; and X: more than 5 scratches.

TABLE 1

| | | | | | | Bending | |
|---|---|---|---|---|---|---|---|
| | | | | | | property | |
| | | | Water | | | (10 mm | Scratch |
| | Transmission | | permeability | Pencil hardness | | curvature | resistance (steel |
| | (%) | Yellowness | (g/m² · day) | (1 kg. 180 mm/min) | Adhesion | radium) | wool 500 times) |
| Example 1 | 91 | 2.4 | >50 | 5H | 5B | OK | ⊚ |
| Example 2 | 90 | 2.5 | >50 | 6H | 5B | OK | ⊚ |
| Example 3 | 91 | 2.1 | 20 | 5H | 5B | OK | ⊚ |
| Example 4 | 90 | 2.5 | 8 | 6H | 5B | OK | ⊚ |
| Comp. | 89 | 2.5 | >50 | H | 5B | OK | X |
| Example 1 | | | | | | | |
| Comp. | 92 | 1.0 | >50 | 2H | 5B | OK | Δ |
| Example 2 | | | | | | | |
| Comp. | 91 | 1.5 | >50 | 2H | — | OK | Δ |
| Example 3 | | | | | | | |

(8) Solvent Resistance

Solvent resistance was evaluated by dipping the coated film in each of the organic solvents shown in Table 2 at room temperature for 30 minutes. The evaluation results were rated on the following criteria: ⊚: no visible change in appearance and a difference of 1 nm or less in RMS between before and after chemical resistance test; ∘: no visible change in appearance and a difference of more than 1 nm in RMS between before and after chemical resistance test; and X: presence of white turbidity or spots in appearance. The results of the evaluation are shown in Table 2 below.

TABLE 2

| | IPA | TMAH | KOH | NMP | MEK | MA-SO₂* |
|---|---|---|---|---|---|---|
| Example 1 | ⊚ | ⊚ | ⊚ | ⊚ | ⊚ | ⊚ |
| Example 2 | ⊚ | ⊚ | ⊚ | ⊚ | ⊚ | ⊚ |
| Example 3 | ⊚ | ⊚ | ⊚ | ⊚ | ⊚ | ⊚ |
| Example 4 | ⊚ | ⊚ | ⊚ | ⊚ | ⊚ | ⊚ |
| Comp. | ⊚ | ◯ | X | X | X | ◯ |
| Example 1 | | | | | | |
| Comp. | ⊚ | ⊚ | ⊚ | ⊚ | ⊚ | ⊚ |
| Example 2 | | | | | | |
| Comp. | ⊚ | ⊚ | ⊚ | ⊚ | ⊚ | ⊚ |
| Example 3 | | | | | | |

*MA-SO₂: Korea Dongwoo fine-chem Co, Etchant

As can be seen in Table 1 above, in the case of Comparative Examples 2 and 3 in which the silicon oxide layer was formed on the surface, the light transmission, the yellowness and the like were improved compared to those of Comparative Example 1 in which the surface was not treated. In the case of Examples 1 to 4 in which the cured layer made of the acrylate-containing polyisocyanate was formed on the surface, scratch resistance was significantly improved. Particularly, the Examples 3 and 4 comprising the silicon oxide layer under the acrylate-containing polyisocyanate showed the most preferable results in terms of water permeability.

As can be seen in Table 2 showing the results of the solvent resistance test of the Examples and the Comparative Examples, Examples 1 to 4 and Comparative Examples 2 and 3 showed no visible change in appearance (solvent resistance: ⊚) and a difference of less than 1 nm in RMS between before and after the test. However, Comparative Example 1 showed poor evaluation results except for some solvents.

1. A transparent polyimide substrate comprising a transparent polyimide film and a cured layer of a polyisocyanate formed on at least one surface of the transparent polyimide film, the polyisocyanate containing an acrylate group and having 2 to 5 isocyanate groups per molecule.

2. The transparent polyimide substrate of claim 1, wherein the polyisocyanate is represented by the following formula 1: 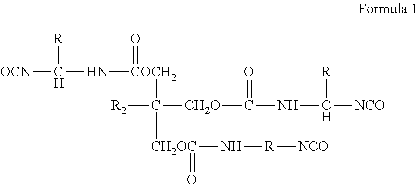
wherein R is 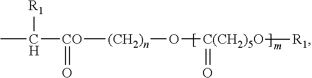
wherein n is
an integer ranging from 0 to 5, m is an integer ranging from 1 to 5, and R₁ is a hydrogen atom or an alkyl group having 1 to 3 carbon atoms; and R₂ is an alkyl group having 1 to 5 carbon atoms.

3. The transparent polyimide substrate of claim 1, wherein the cured layer has a thickness of 1.0-20.0 μm.

4. The transparent polyimide substrate of claim 1, further comprising a silicon oxide layer formed between the transparent polyimide film and the cured layer, the silicon oxide layer comprising a unit structure represented by the following formula 2: 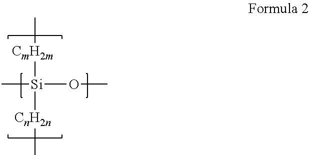
wherein m and n are each an integer ranging from 0 to 10.

5. The transparent polyimide substrate of claim 4, wherein the silicon oxide layer has a thickness of 0.3-2.0 μm.

6. A method for fabricating a transparent polyimide substrate, the method comprising the steps of:
applying a solution containing a polyisocyanate to at least one surface of a transparent polyimide film, the polyisocyanate containing an acrylate group and having 2 to 5 isocyanate groups per molecule, and drying the applied solution, thereby forming a coating layer; and
curing the coating layer to form a cured layer.

7. The method of claim 6, wherein the polyisocyanate is represented by following formula 1: 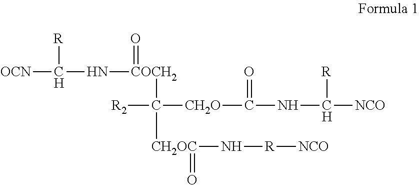
wherein R is 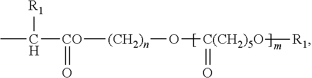
wherein n is an integer ranging from 0 to 5, m is an integer ranging from 1 to 5, and R₁ is a hydrogen atom or an alkyl group having 1 to 3 carbon atoms; and R₂ is an alkyl group having 1 to 5 carbon atoms.

8. The method of claim 6, wherein the solution containing the polyisocyanate further contains a photoinitiator selected from the group consisting of a benzoin ether photoinitiator, a benzophenone photoinitiator and a combination thereof.

9. The method of claim 6, wherein the step of curing the coating layer to form the cured layer is performed by irradiating the coating layer with UV light having a short-wavelength of 312 nm or 365 nm at a dose of 1,500-10,000 J/m².

10. The method of claim 6, wherein the method further comprises, before the step of applying the solution to at least one surface of the transparent polyimide substrate, a step of applying a solution containing a polysilazane to the transparent polyimide film, drying the applied polysilazane solution, and curing the polysilazane to form a silicon oxide layer.

11. The method of claim 10, wherein the polysilazane comprises a unit structure represented by the following formula 3, and the silicon oxide layer comprises a unit structure represented by the following formula 2: 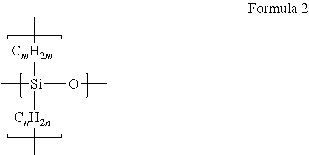
wherein m and n are each an integer ranging from 0 to 10; 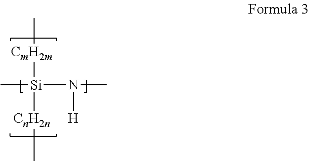
wherein m and n are each an integer ranging from 0 to 10.

12. The method of claim 10, wherein the step of curing the polysilazane to form the silicon oxide layer is performed by heat-treating the polysilazane at a temperature of 200˜300° C.
